(19) United States
(12) Patent Application Publication
(10) Pub. No.: US 2026/0136252 A1
(43) Pub. Date: May 14, 2026

(54) METHOD FOR WIRELESS COMMUNICATION AND DEVICE

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(21) Appl. No.: 19/442,943

(22) Filed: Jan. 7, 2026

Related U.S. Application Data
(63) Continuation of application No. PCT/CN2023/112932, filed on Aug. 14, 2023.

(51) Int. Cl. H04W 36/08; H04W 36/00

(52) U.S. Cl. CPC H04W 36/08; H04W 36/0072

(57) ABSTRACT

Provided are a method for wireless communication and a device. The method comprises: on the basis of a first condition, a first terminal device determines whether to initiate an advance uplink synchronization process to a first LTM candidate cell, wherein the first condition is associated with one or more of: an L1 measurement result of the LTM candidate cell, the location of the terminal device, a first timer, the movement speed of the terminal device, and whether the TA value of the LTM candidate cell is known.

### CROSS-REFERENCE TO RELATED APPLICATIONS

This application is a continuation of International Application No. PCT/CN2023/112932, filed on Aug. 14, 2023, the disclosure of which is hereby incorporated by reference in its entirety.

### TECHNICAL FIELD

This application relates to the field of communications technologies, and more specifically, to a wireless communication method and device.

### RELATED ART

L1/L2-triggered mobility (LTM) supports performing early uplink synchronization between a terminal device and a candidate cell. An early uplink synchronization process is triggered and indicated by a source cell based on an L1 measurement result. In the future, the terminal device may not need to report an L1 measurement result. In this case, how to implement early uplink synchronization between the terminal device and the candidate cell is a problem to be urgently resolved.

### SUMMARY

This application provides a wireless communication method and device. The following describes aspects related to this application.

According to a first aspect, a wireless communication method is provided. The method includes: determining, by a first terminal device according to a first condition, whether to initiate an early uplink synchronization process to a first LTM candidate cell, where the first condition is associated with one or more of the following: an L1 measurement result of the LTM candidate cell; a location of the terminal device; a first timer; a moving speed of the terminal device; or whether a TA value of the LTM candidate cell is known.

According to a second aspect, a terminal device is provided, where the terminal device is a first terminal device, and the terminal device includes a memory and a processor, where the memory is configured to store a computer program, and the processor is configured to execute computer program stored in the memory to cause the terminal device to perform an operation of: determining, according to a first condition, whether to initiate an early uplink synchronization process to a first LTM candidate cell, where the first condition is associated with one or more of the following: an L1 measurement result of the LTM candidate cell; a location of the terminal device; a first timer; a moving speed of the terminal device; or whether a TA value of the LTM candidate cell is known.

According to a third aspect, a network device is provided, including a memory and a processor, where the memory is configured to store a computer program, and the processor is configured to execute computer program stored in the memory to cause the network device to perform an operation of: transmitting first configuration information to a first terminal device, where the first configuration information is used to determine a first condition, and the first condition is used to determine whether to initiate an early uplink synchronization process to a first LTM candidate cell, where the first condition is associated with one or more of the following: an L1 measurement result of the LTM candidate cell; a location of the terminal device; a first timer; a moving speed of the terminal device; or whether a TA value of the LTM candidate cell is known.

### BRIEF DESCRIPTION OF DRAWINGS

FIG. 1 is a schematic diagram of a wireless communications system to which an embodiment of this application is applied.

FIG. 2 is a schematic flowchart of a cell handover process based on L3 measurement/signaling.

FIG. 3 is a schematic diagram of a condition handover procedure.

FIG. 4 is a schematic diagram of an LTM-based cell handover procedure.

FIG. 5 is a schematic flowchart of a wireless communication method according to an embodiment of this application.

FIG. 6 is a schematic flowchart of a wireless communication method according to another embodiment of this application.

FIG. 7 is a schematic structural diagram of a terminal device according to an embodiment of this application.

FIG. 8 is a schematic structural diagram of another terminal device according to an embodiment of this application.

FIG. 9 is a schematic structural diagram of a network device according to an embodiment of this application.

FIG. 10 is a schematic structural diagram of another network device according to an embodiment of this application.

FIG. 11 is a schematic structural diagram of an apparatus according to an embodiment of this application.

### DESCRIPTION OF EMBODIMENTS

Technical solutions in this application are described below with reference to the accompanying drawings.

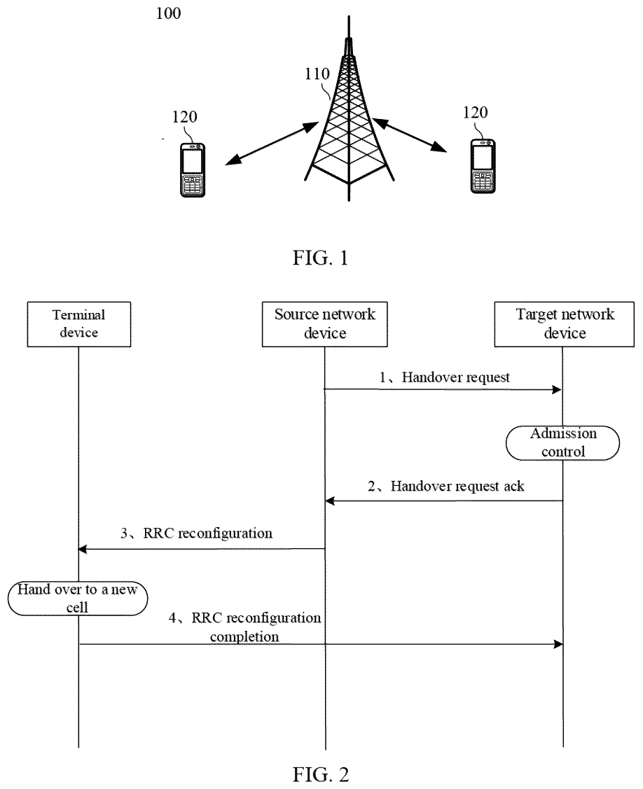

FIG. 1 shows a wireless communications system 100 to which embodiments of this application are applied. The wireless communications system 100 may include a network device 110 and a terminal device 120. The network device 110 may be a device that communicates with the terminal device 120. The network device 110 may provide communication coverage for a specific geographical area, and may communicate with the terminal device 120 located in the coverage.

FIG. 1 schematically shows one network device and two terminals. Optionally, the wireless communications system 100 may include multiple network devices, and coverage of each network device may include another quantity of terminal devices. This is not limited in embodiments of this application.

Optionally, the wireless communications system 100 may further include one or more core network devices. This is not limited in embodiments of this application. For example, the core network device may include one or more of the following: an access and mobility management function (AMF) entity, a session management function (SMF) entity, a user plane function (UPF) entity, or the like.

The AMF entity, for example, may also be referred to as an AMF network element or an AMF function entity. The AMF entity may be configured to be responsible for access management, mobility management, and the like of the terminal device.

The SMF entity, for example, may also be referred to as an SMF network element or an SMF function entity. The SMF entity may be responsible for session management (for example, session establishment of a user), internet protocol (IP) address allocation and management of a terminal device, and the like.

The UPF entity, for example, may also be referred to as a UPF network element or a UPF function entity. The UPF entity may be a user plane functional entity, that is, a user plane gateway. The UPF entity may be configured for packet routing and forwarding, quality of service (QoS) processing of user plane data, and the like. User data may be transmitted to an external network, such as a data network (DN), by using a UPF entity.

Optionally, the wireless communications system 100 may further include another network entity such as a network controller. This is not limited in embodiments of this application. It should be understood that the technical solutions of embodiments of this application may be applied to various communications systems, such as a 5th generation (5G) system or a new radio (NR) system, a long term evolution (LTE) system, an LTE frequency division duplex (FDD) system, and an LTE time division duplex (TDD) system. The technical solutions provided in this application may further be applied to a future communications system, such as a 6th generation mobile communications system or a satellite communications system.

The terminal device in embodiments of this application may also be referred to as a user equipment (UE), an access terminal, a user unit, a user station, a mobile station, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery (remote medical surgery), a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart household device communicate with each other, without relaying a communication signal by using a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or may be replaced with a name in the following, for example, a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (V2X), and machine-to-machine (M2M) communication, a network side device in a 6G network, a device that functions as a base station in a future communications system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may alternatively be implemented by software functions running on hardware, or by virtualization functions instantiated on a platform (for example, a cloud platform).

With the pursuit of speed, delay, high-speed mobility, and efficiency, as well as the diversity and complexity of services in future life, the 3rd generation partnership project (3GPP) International Standards Organization starts to develop 5G. A main application scenario of the 5G may include: enhance mobile broadband (eMBB), ultra reliable low latency communications (URLLC), and massive machine type communication (mMTC).

For ease of understanding, communication processes involved in embodiments of this application are described below.

### Random Access Process

The terminal device may establish a connection to the cell by initiating a random access process, and obtain uplink synchronization information. The random access may include a four-step random access process and a two-step random access process. The random access process may also be classified into a contention based random access (CBRA) process and a contention free random access (CFRA) process. The contention based random access process may include a four-step random access process and a two-step random access process, and the contention free random access process may include a four-step random access process and a two-step random access process.

The four-step random access process may include step 1 to step 4.

In step 1, the terminal device transmits a random access request to the network device, and the random access request may include a random access preamble. The random access request may also be referred to as a first message or a message 1 (Msg1) in a random access process.

In step 2, after detecting the random access preamble transmitted by the terminal device, the network device transmits a random access response (RAR) to the terminal device. The RAR message may also be referred to as a second message or a message 2 (Msg2) in a random access process.

In step 3, the terminal device transmits a message 3 (Msg3) to the network device, where the message 3 may be used to instruct the network device to trigger an event of the random access process. For example, if the event is an initial access random process, the message 3 carries a terminal device identifier and an establishment cause. If the event is radio resource control (RRC) reconstruction, the message 3 carries an identifier of a terminal device in a connected state and an establishment cause.

In step 4, the network device transmits a message 4 (Msg4) to the terminal device, and the message 4 may be used for conflict resolution. Therefore, the message 4 may also be referred to as a contention resolution message.

To reduce delay overheads, a two-step random access is introduced. The two-step random access process may include step 1 and step 2.

In step 1, the terminal device transmits a message A (MsgA) to the network device. The message A may include a message 1 and a message 3 in a four-step random access process.

In step 2, the network device transmits a message B (MsgB) to the terminal device, that is, a random access response. The message B may be used for contention resolution.

### Cell Handover

A cell handover (HO) is intended to improve continuity of service provided by a communications system for a terminal device. In a wireless communications system, a terminal device may move from one cell (also referred to as a “source cell”) to another cell (also referred to as a “target cell”). Generally, cell handover may be classified into two types: a traditional handover mechanism and a conditional handover mechanism.

In embodiments of this application, the source cell may represent a cell that provides a service for the terminal device before handover. The target cell may represent a cell that provides a service for the terminal device after handover.

It should be understood that the cell may be a coverage of the network device, that is, the cell corresponds to the network device. In other words, in embodiments of this application, the source cell corresponds to a source network device (for example, a source base station), and the target cell corresponds to a target network device (for example, a target base station).

It should be further understood that in embodiments of this application, “the source cell” may be replaced with “the network device to which the source cell belongs”, and “the target cell” may be replaced with “the network device to which the target cell belongs”.

It should be further understood that, in embodiments of this application, the source cell and the target cell may belong to a same network device (such as a base station), or the source cell and the target cell may belong to different network devices. In other words, in some embodiments, the source network device and the target network device may refer to a same network device. This is not limited in embodiments of this application.

### Traditional Handover

In a wireless communications system (such as an LTE system or an NR system), when a terminal device that is using a network service moves from one cell to another cell, or because of a wireless transmission service load adjustment, activation operation and maintenance, a device fault, or the like, the system needs to transfer a communication link between the terminal device and an original cell to a new cell, that is, perform a cell handover process, to maintain communication continuity and service quality of the terminal device. The cell handover mechanism may also be referred to as a legacy handover mechanism.

The following briefly describes a cell handover process based on L3 measurement/signaling with reference to FIG. 2.

In step 1, the source network device transmits a handover request to the target network device.

The source network device may trigger handover based on an L3 measurement result reported by the terminal, and transmit the handover request to the target cell by using an Xn interface.

In step 2, the target network device transmits a handover request acknowledge to the source network device.

The target network device may accept a handover request from the source network device, and provide an RRC configuration of the target network device as part of a handover request acknowledgement, for feeding back to the source network device.

In step 3, the source network device transmits an RRC reconfiguration message to the terminal device.

The source network device transmits an RRC reconfiguration message to the terminal device so as to instruct the terminal device to initiate a handover procedure, and transmits an RRC configuration message used to access the target cell to the terminal device.

In step 4, the terminal device transmits an RRC reconfiguration complete message to the target network device.

The terminal device accesses the target cell, and transmits an RRC configuration complete message to the target cell. To perform uplink synchronization with the target cell, the terminal device needs to initiate a random access process to the target cell.

### Conditional Handover (CHO)

The objective of the conditional handover is to improve the reliability and robustness of the subscriber handover, to solve a problem of too late handover due to too long handover preparation time or a problem of handover failure caused by rapid degrading of a channel quality of the source cell during the handover. A core idea of the conditional handover is to preconfigure content of a handover command to the terminal device in advance. When a specific condition is met, the terminal device may independently execute a configuration in the handover command, and directly initiate handover access to a target cell that meets the condition. When the handover condition is met, the terminal device no longer triggers measurement reporting, and the terminal device obtains the configuration in the handover command in advance. Therefore, the foregoing problem that the measurement reporting and the handover command cannot be correctly received is resolved. In particular, for a high-speed moving scenario or a scenario in which signal rapid fading occurs during the handover, a handover success rate can be greatly improved by the conditional handover.

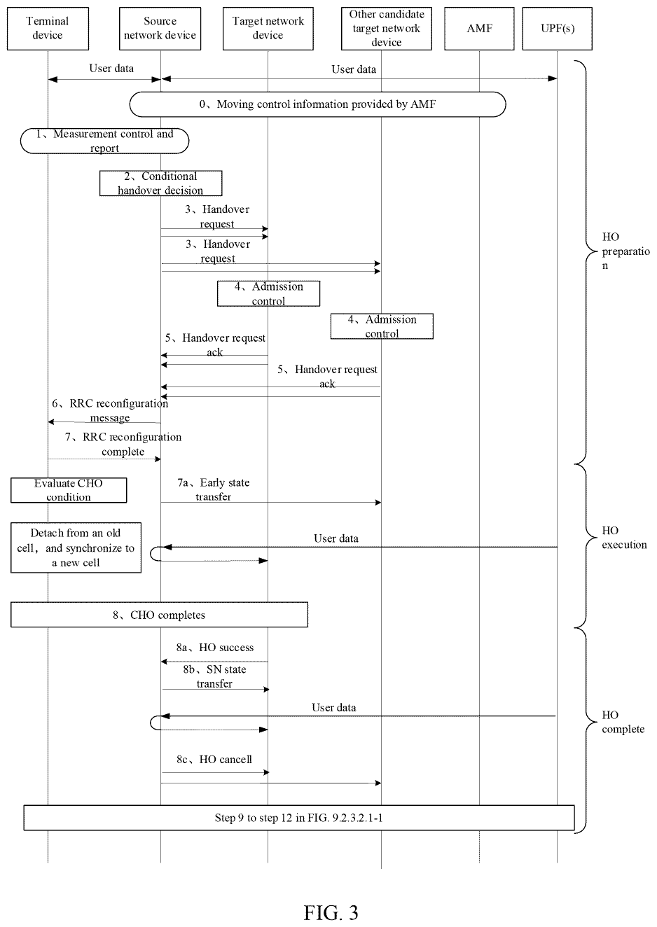

Generally, the handover process may be classified into three stages: handover preparation, handover execution, and handover completion. The following briefly describes a conditional switching process with reference to FIG. 3. The process shown in FIG. 3 may be performed by a terminal device, a source network device (that is, a network device corresponding to a source cell), a target network device (that is, a network device corresponding to a target cell), another candidate target network device, an AMF, and a UPF(s). For example, the source network device may be a source gNB. The target network device may be a target gNB. Another candidate target network device may be another potential gNB (other potential target gNB(s)).

### Phase 1: Handover Preparation (Steps 1 to 7)

In step 1, measurement control and reporting (measurement control and reports) is performed between the source network device and the terminal device. Specifically, the source network device triggers the terminal device to measure a neighboring cell, so that the terminal device may measure the neighboring cell, and report a measurement result to the source network device.

Before step 1, user data may be transmitted between the terminal device and the source network device. User data may be transmitted between the source network device and the UPF.

As shown in FIG. 3, before step 1, the first stage may further include step 0. In step 0, the AMF provides mobile control information (mobility control information provided by AMF).

In step 2, the source network device evaluates the measurement result reported by the terminal device to determine whether to trigger handover (CHO decision).

In step 3, if the source network device decides to trigger the handover, the source network device may transmit a handover request (handover request) to the target network device and another candidate target network device.

In step 4, after receiving the handover request transmitted by the source network device, the target network device and another candidate target network device may perform admission control according to service information carried by the source network device, and perform radio resource configuration.

In step 5, the target network device and another candidate target network device transmit a handover request acknowledgement message (handover request acknowledge) to the source network device. The handover request acknowledgement message includes an RRC reconfiguration message of the target network device and another candidate target network device.

In step 6, after receiving the handover request acknowledgement message of the target network device and the another candidate target network device, the source network device may transmit an RRC reconfiguration message (RRC reconfiguration) of the target network device and the another candidate target network device to the terminal device.

In step 7, the terminal device transmits an RRC reconfiguration complete message to the source network device. At this time, the handover preparation phase is completed.

### Phase 2: Handover Execution (Step 7a to Step 8)

In step 7a, the terminal device evaluates CHO conditions (evaluate the CHO conditions), and performs early status transfer based on an evaluation result. If a conditional handover condition is met, the terminal device detaches from an old cell and performs synchronization with a new cell (detach from the old cell, synchronize to the new cell).

In step 8, the conditional handover is completed (CHO handover completion).

### Phase 3: Handover Completion (Steps 8a to 8c)

In step 8a, the target network device transmits handover success (handover success) information to the source network device.

In step 8b, the source network device may forward buffered data, a data packet being transmitted, a sequence number (SN) associated with data, and the like to the target network device by using SN state transfer.

In step 8c, the source network device transmits handover cancel information to the target network device and another candidate target network device.

In some embodiments, the third phase may further include step 9 to step 12 in FIG. 9.2.3.2.1-1 of a section related to conditional handover in the protocol. For brevity, details are not described herein again.

### LTM

In the related technology, the handover process is triggered by L3 signaling (RRC reconfiguration). To further reduce the delay of L3 handover process, the R18 mobility topic supports the cell handover triggered by L1/L2 signaling, that is, LTM.

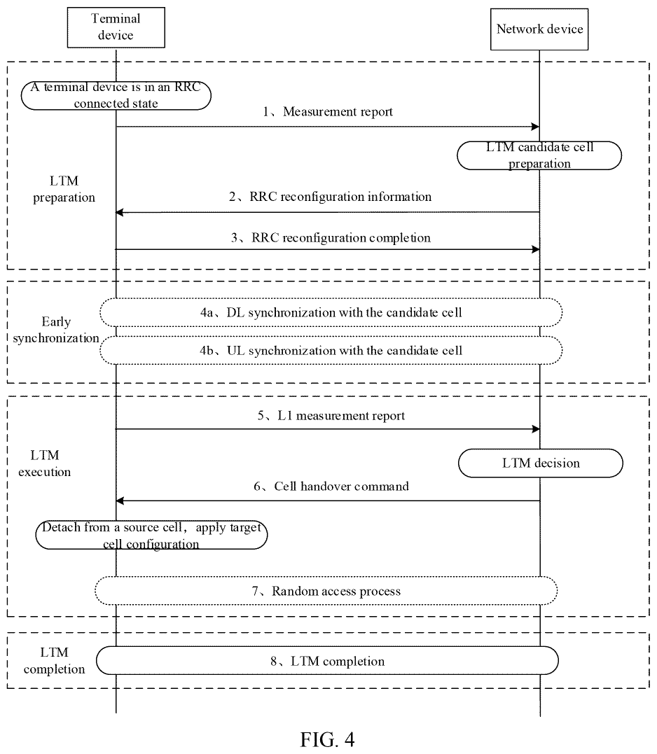

The LTM-based cell handover process may be divided into four phases: LTM preparation, early synchronization, LTM execution and LTM completion. With reference to FIG. 4, the following briefly describes a LTM-based cell handover procedure.

### Phase 1: LTM Preparation (Steps 1 to 3)

In step 1, the terminal device in an RRC connected state reports a measurement report to the network device.

The measurement report in this step is based on L3 measurement. The network device may determine, based on a measurement result, to initiate an LTM process, and trigger candidate cell preparation.

In step 2, the network device transmits an RRC reconfiguration message to the terminal device.

The network device may transmit, to the terminal device, an RRC message (that is, a RRC reconfiguration message) that includes the configuration of the LTM candidate cell. A quantity of the candidate cell is one or more.

In step 3, the terminal device stores the configuration of the LTM candidate cell, and feeds back a RRC reconfiguration complete message (that is, a RRC reconfiguration complete message) to the network device.

### Phase 2: Early Synchronization (Step 4a and Step 4b)

In step 4a, the terminal device performs downlink synchronization with the candidate cell.

In step 4b, the terminal device performs uplink synchronization with the candidate cell.

Before receiving the LTM cell handover command, the terminal device may perform uplink/downlink synchronization with the candidate cell in advance, so as to reduce an interrupt delay in a handover process.

### Phase 3: LTM Execution (Steps 5 to 7)

In step 5, the terminal device performs L1 measurement on each candidate cell, and reports an L1 measurement result to the network device.

In step 6, the network device determines the target cell based on the L1 measurement result reported by the terminal device, and instructs, by using a media access control control element (media access control control element, MAC CE), the terminal device to hand over to the target cell.

In step 7, if the terminal device currently has no valid timing advance (timing advance, TA) of the target cell, the terminal device initiates a random access process to the target cell after receiving the LTM handover indication.

### Phase 4: LTM Completion (Step 8)

In step 8, the LTM is completed.

The mobility topic in the R18 mainly discusses an LTM triggered by a network side, that is, the terminal device first reports an L1 measurement result of a candidate cell (beam) to the network device. The network device determines a target cell based on the received L1 measurement result, and transmits a cell handover instruction to the terminal device by using the MAC CE. A delay generated by reporting a measurement result and transmitting a cell handover instruction may increase a probability of a handover failure. To further enhance the robustness of the LTM process, in a study of a next protocol version (R19), an LTM triggered by a terminal device may be considered, which may be referred to as a conditional LTM.

The R18 LTM supports performing early uplink synchronization between the terminal device and the candidate cell. An early uplink synchronization process is triggered by a physical downlink control channel (PDCCH) order transmitted by the source cell, and the terminal device transmits a preamble to the candidate cell based on the PDCCH order. Different from a conventional random access process, the terminal device is unnecessary to monitor the RAR after completing preamble transmitting. In an LTM execution phase, the network device transmits TA information of the target cell to the terminal device by using an LTM cell handover command. In this way, a handover interrupt delay generated during a process in which the terminal device obtains the target cell TA by using the random access process after receiving the handover command may be avoided.

The source cell determines, based on the L1 measurement result reported by the terminal device, a time when the terminal device initiates an early uplink synchronization process to which candidate cell. However, in the future, the terminal device may not need to report the L1 measurement result. For example, in a conditional LTM, the terminal device may not need to report the L1 measurement result of the candidate cell to the network device. In this case, how to implement early uplink synchronization between the terminal device and the candidate cell is a problem to be urgently resolved.

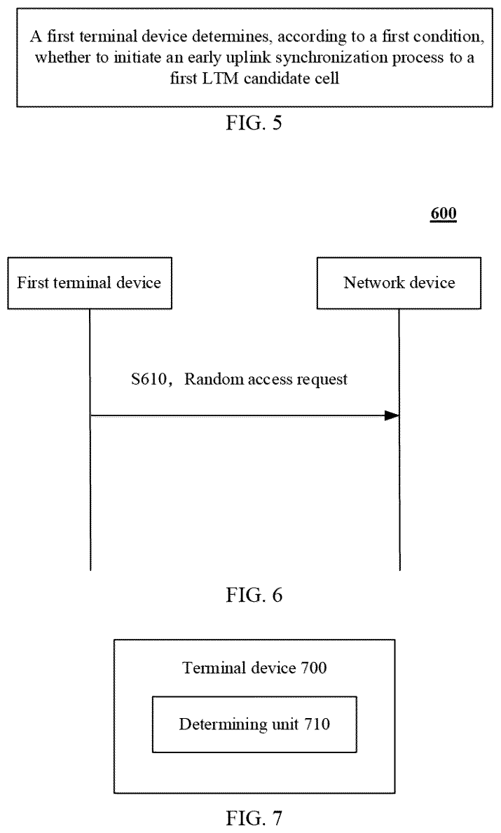

How to implement early uplink synchronization between the terminal device and the candidate cell may include, for example, how to trigger the terminal device to establish uplink synchronization with the candidate cell in advance. FIG. 5 shows a wireless communication method according to an embodiment of this application, to resolve the foregoing problem.

The method shown in FIG. 5 may include step S510.

In step S510, the first terminal device determines, according to a first condition, whether to initiate an early uplink synchronization process to a first LTM candidate cell.

The first LTM candidate cell may be one of the LTM candidate cells configured by the network device for the terminal device. For example, information about the LTM candidate cell may be carried in an RRC message.

The early uplink synchronization mentioned herein may refer to an uplink synchronization process between the terminal device and the LTM candidate cell before the target cell is determined.

In some embodiments, the first condition may be associated with one or more of the following: an L1 measurement result of the LTM candidate cell; a location of the terminal device; a first timer; a moving speed of the terminal device; or whether the TA value of the LTM candidate cell is known.

As described above, in a process of performing conditional LTM, the terminal device may perform L1 measurement on the candidate cell. In some embodiments, the first condition may be associated with the L1 measurement result of the LTM candidate cell. For example, the L1 measurement result of the LTM candidate cell may include a cell measurement result of the LTM candidate cell, or may include a beam measurement result of the LTM candidate cell. That is, the first condition may be associated with the cell measurement result and/or the beam measurement result of the LTM candidate cell. For another example, the L1 measurement result of the LTM candidate cell may include a reference signal received power (RSRP) measurement result. That is, the first condition may be associated with the RSRP measurement result of the LTM candidate cell, for example, the first condition may be associated with the RSRP measurement result of the cell and/or beam of the candidate cell.

Compared with a scenario in which the terminal device obtains the TA of the first LTM candidate cell, a scenario in which the terminal device accesses or prepares to access the first LTM candidate cell may change. If the foregoing scenario changes, for example, the location of the terminal device changes, the TA obtained by the terminal device may not be applicable to a scenario in which the terminal device accesses the first LTM candidate cell, or the terminal device does not have a valid TA value of the candidate cell when accessing or preparing to access the first LTM candidate cell. Therefore, the first condition may be associated with a scenario in which the terminal device obtains the TA and/or a scenario in which the terminal device accesses the first LTM candidate cell. Based on this, when the TA may not be applicable to a current scenario, the terminal device may initiate an early uplink synchronization process to the first LTM candidate cell, or the terminal device is triggered to perform early uplink synchronization with the first LTM candidate cell again, thereby preventing impact of the foregoing scenario change on the TA, and improving TA accuracy.

The foregoing scenario change may include, for example, a change in a location of the terminal device. Therefore, the first condition may be associated with a location of the terminal device. For example, the first condition may be associated with a location change of the terminal device, so as to avoid impact of the location change of the terminal device on the TA.

In some embodiments, the foregoing scenario change may be affected by a moving speed of the terminal device. For example, when the moving speed of the terminal device is relatively fast, the foregoing scenario change is more likely to occur. Therefore, the first condition may be associated with the moving speed of the terminal device.

In some embodiments, the first condition may be associated with a first timer. For example, when the terminal device knows that the TA of the first LTM candidate cell becomes invalid for a specific time, a scenario in which the terminal device is located may change. Therefore, when the first condition is associated with the first timer, impact of change of a scenario in which the terminal device is located on the TA can be prevented. In addition, the first condition is associated with the first timer, thereby preventing impact of multiple changes of the scenario in which the terminal device is located on the TA, and being easy to implement.

In some embodiments, the first condition may be associated with whether the TA value of the LTM candidate cell is known. If the TA value of the LTM candidate cell is known, the terminal device may not need to initiate an uplink synchronization process to the first LTM candidate cell, thereby saving overhead.

The following describes in detail the multiple cases of the first condition provided in the embodiments of this application with reference to specific examples.

In some embodiments, the first condition being associated with a location of the terminal device may include the first condition being associated with a current location of the terminal device and/or a reference location of the terminal device.

It may be learned from the foregoing analysis that the reference location of the terminal device may be, for example, a location at which the terminal device receives the TA of the LTM candidate cell.

For another example, the reference location of the terminal device may further include a location at which the terminal device performs LTM. As an example, in some cases, the terminal device may perform multiple handovers in the LTM candidate cell in a specific time, that is, a current serving cell of the terminal device may be a cell in the LTM candidate cell. In this case, when the terminal device accesses another candidate cell from the current serving cell by using the LTM, the TA value of the current serving cell may be saved, so that the terminal device uses the TA value when returning to the cell again. That is, the TA value is obtained when the terminal device executes the LTM, or the TA value corresponds to a location at which the terminal device performs the LTM.

In some embodiments, when a position difference between the current position and the reference position of the terminal device is relatively large, a TA of the first LTM candidate cell obtained by the terminal device may not be applicable to a scenario in which the terminal device is currently located. Therefore, the first condition may include that the position difference between the current position and the reference position is greater than or equal to a first threshold.

In some embodiments, the location change of the terminal device may be associated with signal quality change of the terminal device. For example, if the signal quality of the terminal device changes greatly, or a signal quality difference between signal quality of the first terminal device at a first location and signal quality of the terminal device at a second location is relatively large, a position difference between the first location and the second location may be relatively large. Therefore, the first condition may further include that a difference between signal quality corresponding to the current location of the terminal device and signal quality corresponding to the reference location of the terminal device is greater than or equal to a second threshold.

For example, the foregoing signal quality may be represented by using a RSRP measurement result. A location change of the terminal device may cause a signal quality change of a current serving cell, or may cause a signal quality change of an LTM candidate cell.

Therefore, the foregoing signal quality may be determined based on the RSRP of the LTM candidate cell and/or the RSRP of the serving cell that are measured by the terminal device. That is, the first condition may include, for example, that a difference between the RSRP of the serving cell corresponding to the current location of the terminal device and the RSRP of the serving cell corresponding to the reference location is greater than or equal to a second threshold; and/or the first condition may include that a difference between the RSRP of the LTM candidate cell corresponding to the current location of the terminal device and the RSRP of the LTM candidate cell corresponding to the reference location is greater than or equal to a second threshold.

In a working process, the terminal device generally measures signal quality, such as measuring RSRP. Therefore, determining of the first condition may reuse an existing signal quality measurement result, thereby reducing overheads of the terminal device.

It should be noted that the two types of reference locations of the terminal device may be used separately or in combination. This is not limited in this application.

In some embodiments, the first condition being associated with the first timer may include that: the first condition is associated with the first timer and an instant at which the terminal device receives the TA value of the LTM candidate cell. For example, a starting instant of the first timer is associated with the instant at which the terminal device receives the TA value of the LTM candidate cell. As an example, the first timer may be started when the terminal device receives the TA value of the LTM candidate cell.

For example, the first condition may include that a first duration is greater than or equal to a timing duration of the first timer. The first duration is determined based on a time difference between an instant at which the terminal device receives the TA value of the LTM candidate cell and a current instant. As an example, the first duration is a time difference between an instant at which the terminal device receives the TA value of the LTM candidate cell and a current instant. That is, when or after the first timer expires, the terminal device initiates an early uplink synchronization process to the LTM candidate cell.

In some embodiments, the first condition being associated with the moving speed of the terminal device may include that the first condition is associated with the moving speed of the terminal device after the TA value of the LTM candidate cell is received by the terminal device.

When a moving speed of the terminal device is very slow or the terminal device does not move, a scenario of the terminal device, such as a location of the terminal device, is less likely to change. When a moving speed of the terminal device is relatively fast, a scenario of the terminal device is more likely to change. Therefore, the first condition may include that the moving speed of the terminal device after the terminal device receives the TA value of the LTM candidate cell is greater than or equal to the third threshold. The moving speed mentioned herein may be an average moving speed of the terminal device, or may be an instantaneous moving speed of the terminal device. In some embodiments, a threshold corresponding to the instantaneous moving speed of the terminal device may be greater than or equal to a threshold corresponding to the average moving speed.

As described above, the first condition may be associated with the L1 measurement result of the LTM candidate cell. For example, the first condition may include that the L1 measurement result of the LTM candidate cell obtained by the terminal device is greater than or equal to a fifth threshold. As mentioned above, the L1 measurement result of the LTM candidate cell may include a cell measurement result of the candidate cell, or may include a beam measurement result of the candidate cell. Therefore, the first condition may include that a cell measurement result of the LTM candidate cell obtained by the terminal device is greater than or equal to a fifth threshold, and/or a beam measurement result of the LTM candidate cell obtained by the terminal device is greater than or equal to the fifth threshold. The beam measurement result mentioned herein may include measurement results of at least N (N is an integer greater than or equal to 1) beams, for example, N is 1. In addition, the foregoing L1 measurement result may include, for example, a RSRP measurement result.

In some embodiments, the foregoing first condition may be preconfigured, or may be determined based on first configuration information transmitted by a network device, such as an RRC configuration message. That is, in some embodiments, the network device may transmit first configuration information to the first terminal device, and the first configuration information may be used to determine the first condition.

In some embodiments, if the first condition is associated with whether the TA value of the LTM candidate cell is known, the first configuration information may be used to indicate whether the TA value of the LTM candidate cell is known. For example, if the first configuration information includes or indicates a TA value of the LTM candidate cell, it may indicate that the TA value of the LTM candidate cell is known. If the first configuration information does not indicate the TA value of the LTM candidate cell, it may indicate that the TA value of the LTM candidate cell is unknown. For another example, the first configuration information may include configuration information of a first type and/or configuration information of a second type, so as to indicate two cases in which the TA value of the LTM candidate cell may be known.

The configuration information of the first type may be used to indicate a TA relationship between a first cell and a second cell. Both the first cell and the second cell are LTM candidate cells of the first terminal device. Alternatively, the first cell is a serving cell of the first terminal device, and the second cell is an LTM candidate cell of the first terminal device. That is, the configuration information of the first type may be used to indicate a TA relationship between the LTM candidate cell and another cell, and the another cell may be a serving cell or may be an LTM candidate cell.

In some embodiments, the TA relationship between the first cell and the second cell may include one or more of the following: whether the first cell and the second cell belong to a same timing advance group (TAG); or an offset between a TA of the first cell and a TA of the second cell.

If the first cell and the second cell belong to a same TAG, TA values of the first cell and the second cell are the same. In this case, the TA relationship between the first cell and the second cell may be indicated by configuring an association relationship between the first cell and the second cell. For example, the first cell and the second cell belonging to a same TAG group may be indicated by a same identifier, or may be indicated by a TA offset between the first cell and the second cell. For example, the offset is 0, thereby improving use flexibility.

If the first configuration information includes the configuration information of the first type, and the TA value of the first cell is known, the TA value of the LTM candidate cell is known.

The configuration information of the second type may be used to indicate that a TA value of the LTM candidate cell is 0. If the first configuration information includes the configuration information of the second type, a TA value of the LTM candidate cell is known.

In embodiments of this application, if the TA value of the LTM candidate cell is known, the terminal device may not initiate an early uplink synchronization process to the LTM candidate cell, thereby saving overheads of the terminal device.

In some embodiments, if the TA value of the LTM candidate cell is unknown, for example the terminal device fails to obtain the configuration information of the first type and/or the configuration information of the second type, or the first configuration information does not include the configuration information of the first type and/or the configuration information of the second type, the terminal device may determine, based on another condition in the foregoing first condition, whether to initiate an early uplink synchronization process to the first LTM candidate cell.

In some embodiments, the foregoing first condition may be preconfigured, or may be determined based on first configuration information transmitted by a network device, such as an RRC configuration message. For example, the first configuration information may include the first threshold and/or the second threshold. For another example, the first configuration information may include the first timer. Optionally, the first configuration information may include a starting condition and a timing duration of the first timer. For another example, the first configuration information may include the third threshold. Optionally, the first configuration information may include a type of a moving speed of the terminal device corresponding to the third threshold, such as an average moving speed and/or an instantaneous moving speed. For another example, the first configuration information may include the fifth threshold. Optionally, the first configuration information may include a type of an L1 measurement result corresponding to the fifth threshold, such as a cell measurement result and/or a beam measurement result. Optionally, the first configuration information may include a parameter of the L1 measurement result corresponding to the fifth threshold, for example, RSRP. For another example, the first configuration information may include configuration information of a first type and/or configuration information of a second type.

It should be noted that the multiple conditions based on which the terminal device determines whether to initiate the early uplink synchronization process to the first LTM candidate cell may be used separately or may be combined with each other. For example, whether the location change of the terminal device meets the first condition may be used in combination with whether the L1 measurement result of the LTM candidate cell meets the first condition. That is, if the location change of the terminal device meets the first condition, whether the L1 measurement result of the first LTM candidate cell meets the first condition needs to be further determined, to determine whether to initiate an early uplink synchronization process to the first LTM candidate cell. For another example, if the moving speed of the terminal device meets the first condition and/or the location change of the terminal device meets the first condition, the terminal device initiates an early uplink synchronization process to the first LTM candidate cell. For another example, if the location change of the terminal device meets the first condition, the terminal device may further determine, based on the first configuration information, whether the TA value of the first LTM candidate cell is known, so as to determine whether to initiate an early uplink synchronization process to the first LTM candidate cell.

It should be noted that the first configuration information may include one or more configuration information, that is, the multiple conditions included in the first condition may be determined based on same configuration information, or may be determined based on different configuration information.

In embodiments of this application, based on a trigger condition (that is, a first condition) for early uplink synchronization, the terminal device may initiate an early uplink synchronization process to the LTM candidate cell, thereby implementing early uplink synchronization between the terminal device and the LTM candidate cell, in a case that the terminal device does not report the L1 measurement result, or in a case that the network device does not trigger the early uplink synchronization and does not indicate the early uplink synchronization resource.

In some embodiments, multiple LTM candidate cells may meet a condition for triggering an early uplink synchronization process, and the terminal device may select the first LTM candidate cell based on a specific rule. For example, multiple LTM candidate cells of the first terminal device meet a first condition, and the first LTM candidate cell is determined from the multiple LTM candidate cells based on one or more of the following: L1 measurement results of the multiple LTM candidate cells; or whether the multiple LTM candidate cells are configured with terminal device-dedicated CFRA resources.

As an example, in the multiple LTM candidate cells that meet the first condition, the terminal device may preferentially select a candidate cell that is more likely to become a target cell of the terminal device. For example, the terminal device may preferentially select a candidate cell with a best L1 measurement result or a candidate cell with a better L1 measurement result. If both a third cell and a fourth cell in the LTM candidate cells meet the first condition, and a RSRP measurement result of the fourth cell is greater than a RSRP measurement result of the third cell, the terminal device may select the fourth cell as the first LTM candidate cell.

In another example, in the multiple LTM candidate cells that meet the first condition, the terminal device may preferentially select a candidate cell configured with a terminal device-dedicated CFRA resource, thereby improving a success probability of early uplink synchronization between the terminal device and the LTM candidate cell.

In some embodiments, the LTM may be a conditional LTM. That is, the process of determining, by the first terminal device according to the first condition, whether to initiate the early uplink synchronization process to the first LTM candidate cell may include that: the first terminal device determines, according to the first condition, whether to initiate the early uplink synchronization process to the first LTM candidate cell during a conditional LTM process or before a conditional LTM process is executed.

In some embodiments, in addition to the first condition, the foregoing first configuration information may further include one or more of the following: at least one candidate cell configuration, a measurement configuration, or a first resource configuration.

The candidate cell configuration may include that each candidate cell configuration is associated with one candidate cell index and an execution condition. The measurement configuration may be used by the terminal device to perform L1 measurement related to the candidate cell. For example, the measurement configuration includes a frequency configuration, a synchronization signal block measurement timing configuration (SS/PBCH block measurement timing configuration, SMTC), and a filtering coefficient. The first resource configuration may include a resource configuration used for an early uplink synchronization process, such as downlink reference information, an uplink reference signal (for example, a sounding reference signal (SRS)), a physical uplink control channel (PUCCH) resource, a physical uplink shared channel (PUSCH) resource, and a random access resource.

How to implement early uplink synchronization between the terminal device and the candidate cell may include, for example, how to determine a resource used to establish early uplink synchronization between by the terminal device and the candidate cell. FIG. 6 is a schematic flowchart of a wireless communication method according to another embodiment of this application, so as to resolve the foregoing problem.

The method shown in FIG. 6 relates to a first terminal device and a network device. The following describes the method provided in embodiments of this application from a perspective of interaction between the first terminal device and the network device. The method shown in FIG. 6 may include step S610.

In step S610, the first terminal device transmits a random access request to the network device. Alternatively, the network device receives the random access request of the first terminal device.

The foregoing random access request is used to perform early uplink synchronization to the LTM candidate cell, and the random access request is associated with the first random access resource, or the first random access resource may be used to transmit the random access request. The first random access resource may include one of the following: a CFRA resource, a two-step CBRA resource, or a four-step CBRA resource.

In an early uplink synchronization process between the first terminal device and the first LTM candidate cell, the first terminal device needs to establish early uplink synchronization to the first LTM candidate cell in a case in which the first terminal device is connected to the current serving cell. In this case, the first terminal device may not be able to obtain, from the first LTM candidate cell, information associated with contention, such as conflict resolution information. Based on this, the first terminal device may preferentially perform early uplink synchronization by using the CFRA resource, so as to improve reliability of the early uplink synchronization process.

In some embodiments, if the network device configures the first CFRA resource and the first CBRA resource for the first terminal device, a priority of the first CFRA resource is higher than a priority of the first CBRA resource. That is, if the terminal device is configured with the CFRA resource and the CBRA resource, the terminal device preferentially uses the CFRA resource to perform early uplink synchronization.

In some embodiments, if the network device configures the first CFRA resource and the first CBRA resource for the first terminal device, the first CBRA resource is used when the first CFRA resource is unavailable. That is, if the terminal device is configured with the CFRA resource and the CBRA resource, and the CFRA resource is unavailable, the terminal device performs early uplink synchronization by using the CBRA resource.

The foregoing first CFRA resource being unavailable, for example, may refer to that a beam measurement result of the LTM candidate cell of the first terminal device is relatively poor. For example, a measurement result of an SSB associated with the CFRA resource is less than or equal to a preset threshold. In this case, the CFRA resource is not used for early uplink synchronization, thereby being beneficial to avoid uplink synchronization failure.

In some embodiments, the first terminal device may determine, based on an indication of the network device, whether CBRA resources can be used for early uplink synchronization. For example, the first terminal device may receive first indication information transmitted by the network device, and the first indication information may be used to indicate whether the first terminal device is allowed to initiate an CBRA-based early uplink synchronization process.

In some embodiments, the method shown in FIG. 6 may further include step S620. In embodiments of this application, the terminal device may obtain, by using the first request, a resource used for early uplink synchronization.

In step S620, the first terminal device transmits the first request to the network device. Alternatively, the network device receives the first request transmitted by the first terminal device.

The foregoing first request may be used to request the network device to allocate a resource used for an early uplink synchronization process, such as a random access channel (RACH) resource or a terminal device-dedicated CFRA resource.

In some embodiments, the first request is triggered when a second condition is not met, and the second condition is associated with one or more of the following: first resource configuration information transmitted by a network device, or a beam measurement result of the LTM candidate cell of the first terminal device.

In some embodiments, the second condition may include that the first resource configuration information includes a resource used by the first terminal device to perform an early uplink synchronization process. That is, if the first resource configuration information does not include the resource used by the first terminal device to perform the early uplink synchronization process, the first terminal device may transmit the foregoing first request to the network device. In some cases, the first terminal device allows to initiate only the CFRA-based early uplink synchronization process, so as to improve reliability of the early uplink synchronization process. Therefore, the second condition may include, for example, that the first resource configuration information includes a terminal device-dedicated CFRA resource. That is, if the first resource configuration information does not include the terminal device-dedicated CFRA resource, the first terminal device may transmit the first request to the network device.

In some embodiments, if the first resource configuration information includes the resource used by the first terminal device for early uplink synchronization, the first terminal device may determine, based on the beam measurement result of the LTM candidate cell of the first terminal device, whether to use the resource to perform early uplink synchronization, thereby improving reliability of the early uplink synchronization result. For example, the second condition may include that the first resource configuration information includes a resource used by the first terminal device for early uplink synchronization, and a measurement result of one or more SSBs is greater than or equal to a fourth threshold. One or more SSBs are associated with a resource that is included in the first resource configuration information and that is used by the first terminal device for early uplink synchronization.

As described above, in some cases, the first terminal device allows to initiate only a CFRA-based early uplink synchronization process. Therefore, the second condition may include, for example, that the first resource configuration information includes a terminal device-dedicated CFRA resource, and a measurement result of one or more SSBs is greater than or equal to a fourth threshold. One or more SSBs are associated with a terminal device-dedicated CFRA resource included in the first resource configuration information.

In some embodiments, whether the first terminal device is allowed to transmit the first request to the network device, or whether the first terminal device is allowed to transmit the first request to the network device in a case in which the second condition is not met may be determined based on an indication of the network device. In other words, whether the first terminal device is allowed to transmit the first request to the network device, or whether the first terminal device is allowed to transmit the first request to the network device in a case in which the second condition is not met may be determined based on an indication of the network device.

In some embodiments, the first request may include one or more of the following information: an index of an LTM candidate cell; an SSB index; indication information of a non-supplementary uplink (NUL, that is, a normal uplink) or a supplementary uplink (SUL); measurement results of some or all beams of LTM candidate cells; or a cell measurement result of the LTM candidate cell.

In some embodiments, the network device may allocate a RACH resource for early uplink synchronization to the terminal device by using a PDCCH order. For example, in response to the first request, the network device may allocate, to the terminal device by using the PDCCH order, a RACH resource used for early uplink synchronization.

In some embodiments, if the first resource configuration information includes a terminal device-dedicated CFRA resource, or the first resource configuration information includes a terminal device-dedicated CFRA resource, and the first terminal device allows to initiate only a CFRA-based early uplink synchronization process, the first random access resource may be a terminal device-dedicated CFRA resource in the first resource configuration information transmitted by the network device.

In some embodiments, if the first resource configuration information includes the terminal device-dedicated CFRA resource, or the first terminal device allows to initiate only the CFRA-based early uplink synchronization process, and the first resource configuration information includes the terminal device-dedicated CFRA resource, the first random access resource may be a resource with better quality or better measurement result (for example, a measurement result of a signal associated with the terminal device-dedicated CFRA resource) in the terminal device-dedicated CFRA resource, or the first random access resource may be any resource (that is, the resource may be randomly selected) in the terminal device-dedicated CFRA resource. For example, the terminal device-dedicated CFRA resource is associated one or more SSBs. If a measurement result of a first SSB in at least one SSB is greater than or equal to a fourth threshold, the first random access resource is a terminal device-dedicated CFRA resource associated with the first SSB. If a measurement result of the at least one SSB is less than the fourth threshold, the first random access resource is a terminal device-dedicated CFRA resource associated with a second SSB in the at least one SSB. The second SSB is randomly selected by the first terminal device from the at least one SSB.

In some cases, for example, when the third condition is met, the early uplink synchronization process between the first terminal device and the LTM candidate cell stops. The third condition may include one or more of the following: channel quality of an LTM candidate cell does not meet a trigger condition of an early uplink synchronization process; a CFRA resource on which the early uplink synchronization process is based is unavailable; there are other LTM candidate cells whose L1 measurement result is better than that of the LTM candidate cell; or an event of triggering random access to the serving cell occurs.

The triggering condition of the uplink synchronization process may be the first condition. For example, the third condition may include that the cell measurement result and/or the beam measurement result of the LTM candidate cell do not meet the fifth threshold. The cell measurement result and/or the beam measurement result mentioned herein may refer to a measurement result of the RSRP.

The CFRA resource on which the early uplink synchronization process is based being unavailable may include that: a measurement result of at least one SSB associated with a terminal device-dedicated CFRA resource is less than a fourth threshold; or a measurement result of at least one SSB associated with a terminal device-dedicated CFRA resource is less than a fourth threshold, and the first terminal device allows to initiate only an early uplink synchronization process based on the CFRA resource.

When the terminal device needs to execute the random access process with the serving cell and the first LTM candidate cell at the same time, to ensure communication quality of the first terminal device, the terminal device may preferentially execute the random access process with the serving cell. For example, when an event of triggering initiation of random access to the serving cell occurs, the first terminal device preferentially initiates a random access process to the serving cell, that is, the early uplink synchronization process between the first terminal device and the LTM candidate cell stops.

As mentioned above, the random access process may include a two-step random access process and a four-step random access process. If the first random access resource is a two-step CBRA resource, a payload of a message A transmitted by the first terminal device includes one or more of the following information: a cell radio network temporary identifier (cell radio network temporary identifier, C-RNTI) configured by an LTM candidate cell for the first terminal device; an identifier of a serving cell; an identifier of a serving DU; or an identifier of a serving CU. If the first random access resource is a four-step CBRA resource, a message 3 transmitted by the first terminal device includes one or more of the following information: a C-RNTI configured by the LTM candidate cell for the first terminal device; an identifier of a serving cell; an identifier of a serving DU; or an identifier of the serving CU.

It should be noted that the foregoing measurement result of the SSB may be, for example, a synchronization signal reference signal received power (SS-RSRP) measurement result (or may be referred to as a SS-RSRP measurement result of the SSB). The SS-RSRP measurement result of the SSB may refer to an average power of a synchronization signal on all resource elements (RE) (or referred to as a resource unit).

In embodiments of this application, a resource (that is, a first random resource) used to initiate early uplink synchronization may be flexibly determined based on multiple cases regarding the terminal device and the LTM candidate cell, thereby implementing early uplink synchronization between the terminal device and the LTM candidate cell without reporting an L1 measurement result by the terminal device.

The foregoing describes the method embodiments of this application in detail with reference to FIG. 1 to FIG. 6. The following describes the apparatus embodiments of this application in detail with reference to FIG. 7 to FIG. 11. It should be understood that the descriptions of the method embodiments correspond to descriptions of the apparatus embodiments, and therefore, for parts that are not described in detail, reference may be made to the foregoing method embodiments.

FIG. 7 is a schematic structural diagram of a terminal device according to an embodiment of this application. The terminal device 700 may include a determining unit 710.

The determining unit 710 is configured to determine, according to a first condition, whether to initiate an early uplink synchronization process to a first LTM candidate cell. The first condition is associated with one or more of the following: an L1 measurement result of the LTM candidate cell; a location of the terminal device; a first timer; a moving speed of the terminal device; or whether a TA value of the LTM candidate cell is known.

In some embodiments, the first condition being associated with a location of the terminal device includes: the first condition being associated with a current location of the terminal device and/or a reference location of the terminal device.

In some embodiments, the reference location includes one of the following: a location at which the terminal device is located when receiving the TA of the LTM candidate cell; or a location at which the terminal device is located when executing the LTM.

In some embodiments, the first condition includes one or more of: a location difference between the current location and the reference location is greater than or equal to a first threshold; or a difference between signal quality corresponding to the current location and signal quality corresponding to the reference location is greater than or equal to a second threshold.

In some embodiments, the signal quality is determined based on an RSRP of the LTM candidate cell and/or an RSRP of a serving cell measured by the terminal device.

In some embodiments, the first condition being associated with the first timer includes: the first condition being associated with the first timer and an instant at which the terminal device receives the TA value of the LTM candidate cell.

In some embodiments, the first condition includes: a first duration being greater than or equal to a timing duration of the first timer; where the first duration is determined based on a time difference between an instant at which the terminal device receives the TA value of the LTM candidate cell and a current instant.

In some embodiments, the first condition being associated with the moving speed of the terminal device includes: the first condition being associated with a moving speed of the terminal device after the TA value of the LTM candidate cell is received by the terminal device.

In some embodiments, the first condition includes: a moving speed or an average moving speed of the terminal device after the terminal device receives the TA value of the LTM candidate cell being greater than or equal to a third threshold.

In some embodiments, the first condition is determined based on first configuration information transmitted by the network device.

In some embodiments, if the first condition is associated with whether the TA value of the LTM candidate cell is known, the first configuration information includes configuration information of a first type, and the configuration information of the first type is used to indicate a TA relationship between a first cell and a second cell. In which, both the first cell and the second cell are LTM candidate cells of the first terminal device; or the first cell is a serving cell of the first terminal device, and the second cell is an LTM candidate cell of the first terminal device.

In some embodiments, the TA relationship between the first cell and the second cell includes one or more of the following: whether the first cell and the second cell belong to a same TAG; or an offset between a TA of the first cell and a TA of the second cell.

In some embodiments, if the first configuration information includes the configuration information of the first type, and a TA value of the first cell is known, the TA value of the LTM candidate cell is known.

In some embodiments, if the first condition is associated with whether the TA value of the LTM candidate cell is known, the first configuration information includes configuration information of a second type, and the configuration information of the second type is used to indicate that the TA value of the LTM candidate cell is 0.

In some embodiments, the first configuration information is carried in an RRC configuration message.

In some embodiments, a plurality of LTM candidate cells of the first terminal device meet the first condition, and the first LTM candidate cell is determined from the plurality of LTM candidate cells based on one or more of the following: L1 measurement results of the plurality of LTM candidate cells; or whether the plurality of LTM candidate cells are configured with a CFRA resource dedicated to the terminal device.

In some embodiments, the first LTM candidate cell is an LTM candidate cell with a best L1 measurement result in the plurality of LTM candidate cells; or the first LTM candidate cell is an LTM candidate cell in the plurality of LTM candidate cells that is configured with the CFRA resource dedicated to the terminal device.

In some embodiments, the determining unit is configured to: in a conditional LTM process, determine, according to the first condition, whether to initiate the early uplink synchronization process to the first LTM candidate cell.

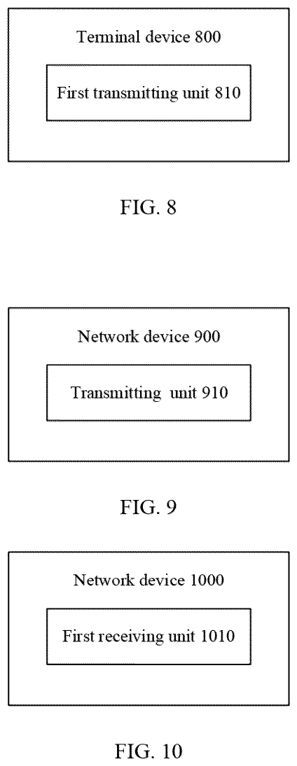

FIG. 8 is a schematic structural diagram of another terminal device according to an embodiment of this application. The terminal device 800 may include a first transmitting unit 810.

The first transmitting unit 810 is configured to transmit a random access request to a network device, where the random access request is used to perform early uplink synchronization with an LTM candidate cell, the random access request is associated with a first random access resource, and the first random access resource includes one of the following: a CFRA resource; a two-step CBRA resource; or a four-step CBRA resource.

In some embodiments, if the network device configures a first CFRA resource and a first CBRA resource for the first terminal device, a priority of the first CFRA resource is higher than a priority of the first CBRA resource; or if the network device configures a first CFRA resource and a first CBRA resource for the first terminal device, the first CBRA resource is used when the first CFRA resource is unavailable.

In some embodiments, the device further includes a receiving unit, configured to receive first indication information transmitted by the network device, where the first indication information is used to indicate whether the first terminal device is allowed to initiate an CBRA-based early uplink synchronization process.

In some embodiments, the device further includes a second transmitting unit, configured to transmit a first request to the network device, where the first request is used to request the network device to allocate a RACH resource or a terminal device-dedicated CFRA resource that is used for an early uplink synchronization process.

In some embodiments, the first request is triggered when a second condition is not met, and the second condition is associated with one or more of the following: first resource configuration information transmitted by the network device; or a beam measurement result of the LTM candidate cell of the first terminal device.

In some embodiments, the second condition includes that: the first resource configuration information includes a terminal device-dedicated CFRA resource; and a measurement result of at least one SSB is greater than or equal to a fourth threshold, where the at least one SSB is associated with the terminal device-dedicated CFRA resource included in the first resource configuration information.

In some embodiments, the first request includes one or more of the following information: an index of the LTM candidate cell; an SSB index; indication information of a NUL or a SUL; a measurement result of part or all of beams of the LTM candidate cell; or a cell measurement result of the LTM candidate cell.

In some embodiments, the first random access resource is the terminal device-dedicated CFRA resource in the first resource configuration information transmitted by the network device.

In some embodiments, the first resource configuration information includes a terminal device-dedicated CFRA resource, the terminal device-dedicated CFRA resource is associated with at least one SSB, a measurement result of a first SSB in the at least one SSB is greater than or equal to a fourth threshold, and the first random access resource is a terminal device-dedicated CFRA resource associated with the first SSB; or the first resource configuration information includes a terminal device-dedicated CFRA resource, the terminal device-dedicated CFRA resource is associated with at least one SSB, a measurement result of the at least one SSB is less than the fourth threshold, the first random access resource is a terminal device-dedicated CFRA resource associated with a second SSB in the at least one SSB, and the second SSB is randomly selected by the first terminal device from the at least one SSB.

In some embodiments, the first terminal device allows to initiate only a CFRA-based early uplink synchronization process.

In some embodiments, if a third condition is met, the early uplink synchronization process between the first terminal device and the LTM candidate cell stops. The third condition includes one or more of the following: channel quality of the LTM candidate cell does not meet a trigger condition of the early uplink synchronization process; a CFRA resource on which the early uplink synchronization process is based is unavailable; there is another LTM candidate cell whose L1 measurement result is better than that of the LTM candidate cell; or an event of triggering random access to a serving cell occurs.

In some embodiments, if the first random access resource is a two-step CBRA resource, a payload of a message A transmitted by the first terminal device includes one or more of the following information: a C-RNTI configured by the LTM candidate cell for the first terminal device; an identifier of a serving cell; an identifier of a serving DU; or an identifier of a serving CU.

In some embodiments, if the first random access resource is a four-step CBRA resource, a message 3 transmitted by the first terminal device includes one or more of the following information: a C-RNTI configured by the LTM candidate cell for the first terminal device; an identifier of a serving cell; an identifier of a serving DU; or an identifier of a serving CU.

FIG. 9 is a schematic structural diagram of a network device according to an embodiment of this application. The network device 900 may include a transmitting unit 910.

The transmitting unit 910 is configured to transmit first configuration information to a first terminal device, where the first configuration information is used to determine a first condition, and the first condition is used to determine whether to initiate an early uplink synchronization process to a first LTM candidate cell. The first condition is associated with one or more of the following: an L1 measurement result of the LTM candidate cell; a location of the terminal device; a first timer; a moving speed of the terminal device; or whether a TA value of the LTM candidate cell is known.

In some embodiments, the first condition being associated with a location of the terminal device includes: the first condition being associated with a current location of the terminal device and/or a reference location of the terminal device.

In some embodiments, the reference location includes one of the following: a location at which the terminal device is located when receiving the TA of the LTM candidate cell; or a location at which the terminal device is located when executing the LTM.

In some embodiments, the first condition includes one or more of the following: a location difference between the current location and the reference location is greater than or equal to a first threshold; or a difference between signal quality corresponding to the current location and signal quality corresponding to the reference location is greater than or equal to a second threshold.

In some embodiments, the signal quality is determined based on an RSRP of the LTM candidate cell and/or an RSRP of a serving cell measured by the terminal device.

In some embodiments, the first condition being associated with the first timer includes: the first condition being associated with the first timer and an instant at which the terminal device receives the TA value of the LTM candidate cell.

In some embodiments, the first condition includes: a first duration being greater than or equal to a timing duration of the first timer; where the first duration is determined based on a time difference between an instant at which the terminal device receives the TA value of the LTM candidate cell and a current instant.

In some embodiments, the first condition being associated with the moving speed of the terminal device includes: the first condition being associated with a moving speed of the terminal device after the TA value of the LTM candidate cell is received by the terminal device.

In some embodiments, the first condition includes: a moving speed or an average moving speed of the terminal device after the terminal device receives the TA value of the LTM candidate cell being greater than or equal to a third threshold.

In some embodiments, if the first condition is associated with whether the TA value of the LTM candidate cell is known, the first configuration information includes configuration information of a first type, and the configuration information of the first type is used to indicate a TA relationship between a first cell and a second cell. In which, both the first cell and the second cell are LTM candidate cells of the first terminal device; or the first cell is a serving cell of the first terminal device, and the second cell is an LTM candidate cell of the first terminal device.

In some embodiments, a TA relationship between the first cell and the second cell includes one or more of the following: whether the first cell and the second cell belong to a same TAG; or an offset between a TA of the first cell and a TA of the second cell.

In some embodiments, if the first configuration information includes the configuration information of the first type, and a TA value of the first cell is known, the TA value of the LTM candidate cell is known.

In some embodiments, if the first condition is associated with whether the TA value of the LTM candidate cell is known, the first configuration information includes configuration information of a second type, and the configuration information of the second type is used to indicate that the TA value of the LTM candidate cell is 0.

In some embodiments, the first configuration information is carried in an RRC configuration message.

In some embodiments, a plurality of LTM candidate cells of the first terminal device meet the first condition, and the first LTM candidate cell is determined from the plurality of LTM candidate cells based on one or more of the following: L1 measurement results of the plurality of LTM candidate cells; or whether the plurality of LTM candidate cells are configured with a CFRA resource dedicated to the terminal device.

In some embodiments, the first LTM candidate cell is an LTM candidate cell with a best L1 measurement result in the plurality of LTM candidate cells; or the first LTM candidate cell is an LTM candidate cell in the plurality of LTM candidate cells that is configured with the CFRA resource dedicated to the terminal device.

In some embodiments, the process of transmitting, by the network device, first configuration information to a first terminal device includes: in a conditional LTM process, the network device transmits the first configuration information to the first terminal device.

FIG. 10 is a schematic structural diagram of a network device according to an embodiment of this application. The network device 1000 may include a first receiving unit 1010.

The first receiving unit 1010 is configured to receive a random access request transmitted by a first terminal device, where the random access request is used to perform early uplink synchronization with an LTM candidate cell, the random access request is associated with a first random access resource, and the first random access resource includes one of the following: a CFRA resource; a two-step CBRA resource; or a four-step CBRA resource.

In some embodiments, if the network device configures a first CFRA resource and a first CBRA resource for the first terminal device, a priority of the first CFRA resource is higher than a priority of the first CBRA resource; or if the network device configures a first CFRA resource and a first CBRA resource for the first terminal device, the first CBRA resource is used when the first CFRA resource is unavailable.

In some embodiments, the device further includes a transmitting unit, configured to transmit first indication information to the first terminal device, where the first indication information is used to indicate whether the first terminal device is allowed to initiate an CBRA-based early uplink synchronization process.

In some embodiments, the device further includes a second receiving unit, configured to receive a first request transmitted by the first terminal device, where the first request is used to request the network device to allocate a RACH resource or a terminal device-dedicated CFRA resource that is used for an early uplink synchronization process.

In some embodiments, the first request is triggered when a second condition is not met, and the second condition is associated with one or more of the following: first resource configuration information transmitted by the network device; or a beam measurement result of the LTM candidate cell of the first terminal device.

In some embodiments, the second condition includes: the first resource configuration information includes a terminal device-dedicated CFRA resource; and a measurement result of at least one SSB is greater than or equal to a fourth threshold, where the at least one SSB is associated with the CFRA resource included in the first resource configuration information.

In some embodiments, the first request includes one or more of the following information: an index of the LTM candidate cell; an SSB index; indication information of a NUL or a SUL; a measurement result of part or all of beams of the LTM candidate cell; or a cell measurement result of the LTM candidate cell.

In some embodiments, the first random access resource is the terminal device-dedicated CFRA resource in the first resource configuration information transmitted by the network device.

In some embodiments, the first resource configuration information includes a terminal device-dedicated CFRA resource, the terminal device-dedicated CFRA resource is associated with at least one SSB, a measurement result of a first SSB in the at least one SSB is greater than or equal to a fourth threshold, and the first random access resource is a terminal device-dedicated CFRA resource associated with the first SSB; or the first resource configuration information includes a terminal device-dedicated CFRA resource, the terminal device-dedicated CFRA resource is associated with at least one SSB, a measurement result of the at least one SSB is less than the fourth threshold, the first random access resource is a terminal device-dedicated CFRA resource associated with a second SSB in the at least one SSB, and the second SSB is randomly selected by the first terminal device from the at least one SSBs.

In some embodiments, the first terminal device allows to initiate only a CFRA-based early uplink synchronization process.

In some embodiments, if a third condition is met, the early uplink synchronization process between the first terminal device and the LTM candidate cell stops. The third condition includes one or more of the following: channel quality of the LTM candidate cell does not meet a trigger condition of the early uplink synchronization process; a CFRA resource on which the early uplink synchronization process is based is unavailable; there is another LTM candidate cell whose L1 measurement result is better than that of the LTM candidate cell; or an event of triggering random access to a serving cell occurs.

In some embodiments, if the first random access resource is a two-step CBRA resource, a payload of a message A transmitted by the first terminal device includes one or more of the following information: a C-RNTI configured by the LTM candidate cell for the first terminal device; an identifier of a serving cell; an identifier of a serving DU; or an identifier of a serving CU.

In some embodiments, if the first random access resource is a four-step CBRA resource, a message 3 transmitted by the first terminal device includes one or more of the following information: a C-RNTI configured by the LTM candidate cell for the first terminal device; an identifier of a serving cell; an identifier of a serving DU; or an identifier of a serving CU.

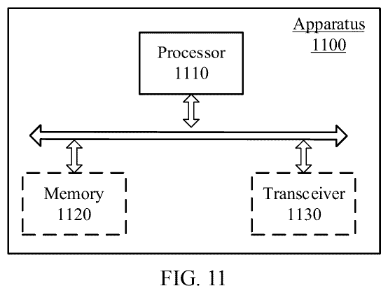

In an optional embodiment, the foregoing transmitting unit and receiving unit may be a transceiver 1130. The terminal device 700, the terminal device 800, the network device 900, and the network device 1000 may further include a processor 1110 and a memory 1120, which are specifically shown in FIG. 11.

FIG. 11 is a schematic structural diagram of a communications apparatus according to an embodiment of this application. A dashed line in FIG. 11 indicates that the unit or module is optional. The apparatus 1100 may be configured to implement the method described in the foregoing method embodiments. The apparatus 1100 may be a chip, a terminal device, or a network device.

The apparatus 1100 may include one or more processors 1110. The processor 1110 may support the apparatus 1100 to implement the method described in the foregoing method embodiments. The processor 1110 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

The apparatus 1100 may further include one or more memories 1120. The memory 1120 stores a program, and the program may be executed by the processor 1110, so that the processor 1110 executes the method described in the foregoing method embodiments. The memory 1120 may be independent of or integrated into the processor 1110.

The apparatus 1100 may further include a transceiver 1130. The processor 1110 may communicate with another device or chip by using the transceiver 1130. For example, the processor 1110 may perform data transmitting and receiving with another device or chip by using the transceiver 1130.

An embodiment of this application further provides a computer-readable storage medium, configured to store a program. The computer-readable storage medium may be applied to the terminal or the network device provided in the embodiments of this application, and the program causes the computer to execute the method executed by the terminal device or the network device in the embodiments of this application.

An embodiment of this application further provides a computer program product. The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal device or the network device provided in the embodiments of this application, and the computer program causes the computer to execute the methods executed by the terminal device or the network device in the embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, the mentioned “include” may be directly included, or indirectly included. Optionally, “include” mentioned in embodiments of this application may be replaced with “indicate” or “used for determining”. For example, A includes B, which may be replaced with A indicates B, or A is used to determine B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “preconfigured” may be implemented by pre-storing corresponding code or a corresponding table in a device (for example, including a terminal device and a network device) or in other manners that can be used for indicating related information, and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

Some or all of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on a computer, the procedures or functions according to embodiments of the present application are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A terminal device, wherein the terminal device is a first terminal device, and the terminal device comprises a memory and a processor, wherein the memory is configured to store a computer program, and the processor is configured to execute computer program stored in the memory to cause the terminal device to perform an operation of:
determining, according to a first condition, whether to initiate an early uplink synchronization process to a first L1/L2-triggered mobility LTM candidate cell,
wherein the first condition is associated with one or more of the following:
an L1 measurement result of the LTM candidate cell;
a location of the terminal device;
a first timer;
a moving speed of the terminal device; or
whether a timing advance TA value of the LTM candidate cell is known.

2. The device according to claim 1, wherein the first condition being associated with a location of the terminal device comprises: the first condition being associated with a current location of the terminal device and/or a reference location of the terminal device.

3. The device according to claim 2, wherein the reference location comprises one of the following:
a location at which the terminal device is located when receiving the TA of the LTM candidate cell; or
a location at which the terminal device is located when executing the LTM.

4. The device according to claim 2, wherein the first condition comprises one or more of the following:
a location difference between the current location and the reference location is greater than or equal to a first threshold; or
a difference between signal quality corresponding to the current location and signal quality corresponding to the reference location is greater than or equal to a second threshold.

5. The device according to claim 4, wherein the signal quality is determined based on reference signal received power RSRP of the LTM candidate cell and/or an RSRP of a serving cell measured by the terminal device.

6. The device according to claim 1, wherein the first condition being associated with the first timer comprises: the first condition being associated with the first timer and an instant at which the terminal device receives the TA value of the LTM candidate cell.

7. The device according to claim 6, wherein the first condition comprises: a first duration being greater than or equal to a timing duration of the first timer; wherein the first duration is determined based on a time difference between an instant at which the terminal device receives the TA value of the LTM candidate cell and a current instant.

8. The device according to claim 1, wherein the first condition is determined based on first configuration information transmitted by a network device.

9. The device according to claim 8, wherein if the first condition is associated with whether the TA value of the LTM candidate cell is known, the first configuration information comprises configuration information of a first type, and the configuration information of the first type is used to indicate a TA relationship between a first cell and a second cell;
wherein both the first cell and the second cell are LTM candidate cells of the first terminal device; or
the first cell is a serving cell of the first terminal device, and the second cell is an LTM candidate cell of the first terminal device.

10. The device according to claim 9, wherein the TA relationship between the first cell and the second cell comprises one or more of the following:
whether the first cell and the second cell belong to a same timing advance group TAG; or
an offset between a TA of the first cell and a TA of the second cell.

11. The device according to claim 9, wherein if the first configuration information comprises the configuration information of the first type, and a TA value of the first cell is known, the TA value of the LTM candidate cell is known.

12. The device according to claim 8, wherein if the first condition is associated with whether the TA value of the LTM candidate cell is known, the first configuration information comprises configuration information of a second type, and the configuration information of the second type is used to indicate that the TA value of the LTM candidate cell is 0.

13. The device according to claim 1, wherein a plurality of LTM candidate cells of the first terminal device meet the first condition, and the first LTM candidate cell is determined from the plurality of LTM candidate cells based on one or more of the following:
L1 measurement results of the plurality of LTM candidate cells; or
whether the plurality of LTM candidate cells are configured with a contention free random access CFRA resource dedicated to the terminal device.

14. The device according to claim 13, wherein:
the first LTM candidate cell is an LTM candidate cell with a best L1 measurement result in the plurality of LTM candidate cells; or
the first LTM candidate cell is an LTM candidate cell in the plurality of LTM candidate cells that is configured with the CFRA resource dedicated to the terminal device.

15. The device according to claim 1, wherein the device is configured to:
in a conditional LTM process, determine, according to the first condition, whether to initiate the early uplink synchronization process to the first LTM candidate cell.

16. A network device, comprising a memory and a processor, wherein the memory is configured to store a computer program, and the processor is configured to execute computer program stored in the memory to cause the network device to perform an operation of:
transmitting first configuration information to a first terminal device, wherein the first configuration information is used to determine a first condition, and the first condition is used to determine whether to initiate an early uplink synchronization process to a first L1/L2-triggered mobility LTM candidate cell,
wherein the first condition is associated with one or more of the following:
an L1 measurement result of the LTM candidate cell;
a location of the terminal device;
a first timer;
a moving speed of the terminal device; or
whether a timing advance TA value of the LTM candidate cell is known.

17. The device according to claim 16, wherein the first condition being associated with a location of the terminal device comprises: the first condition being associated with a current location of the terminal device and/or a reference location of the terminal device.

18. The device according to claim 17, wherein the reference location comprises one of the following:
a location at which the terminal device is located when receiving the TA of the LTM candidate cell; or
a location at which the terminal device is located when executing the LTM.

19. The device according to claim 17, wherein the first condition comprises one or more of the following:
a location difference between the current location and the reference location is greater than or equal to a first threshold; or
a difference between signal quality corresponding to the current location and signal quality corresponding to the reference location is greater than or equal to a second threshold.

20. A wireless communication method, comprising:
determining, by a first terminal device according to a first condition, whether to initiate an early uplink synchronization process to a first L1/L2-triggered mobility LTM candidate cell,
wherein the first condition is associated with one or more of the following:
an L1 measurement result of the LTM candidate cell;
a location of the terminal device;
a first timer,
a moving speed of the terminal device; or
whether a timing advance TA value of the LTM candidate cell is known.
